(19) United States
(12) Patent Application Publication
(10) Pub. No.: US 2024/0367568 A1
(43) Pub. Date: Nov. 7, 2024

(54) Automobile Gap Filling Device

(71) Applicants: Olufisayo Abegunde, Elkridge, MD (US); Kofoworola Abegunde, Randallstown, MD (US)

(72) Inventors: Olufisayo Abegunde, Elkridge, MD (US); Kofoworola Abegunde, Randallstown, MD (US)

(21) Appl. No.: 18/655,014

(22) Filed: May 3, 2024

Related U.S. Application Data
(60) Provisional application No. 63/499,788, filed on May 3, 2023.

(51) Int. Cl. B60N 2/90

(52) U.S. Cl. CPC B60N 2/90

(57) ABSTRACT

The present invention is an automobile gap filling device that has a connecting web, gap pockets, a light module, and a remote controller. The connecting web is split into separate straps wherein there is a rear strap and front straps. The rear strap has loops along the ends and the front straps have loops and fasteners along opposite ends. These allow the connecting web to secure to the gap pockets and light module. The gap pockets has a left pocket, a right pocket, a gap pocket proximal end, and a gap pocket distal end. The gap pocket proximal end has fasteners and a top lip. The light module, which is designed to emit a light, has fastener receivers, a light receiver, and a light fixture. The connecting web secures the gap pockets to each other below an automobile vehicle seat, allowing the present invention to catch falling objects.

### FIELD OF THE INVENTION

The present invention relates generally to car accessories, and more specifically to a device for arranging around an automobile seat to catch fallen items.

### BACKGROUND OF THE INVENTION

Automobiles are often designed with small gaps between the seats and consoles or between the seats and doors, particularly with seats in the front of an automobile. Items that are dropped by the user of a seat or otherwise fall off the user's person often slide into these gaps. Due to the size of the gaps and the various components of the seat of a car, it can be difficult to see and/or reach an item that has fallen off the seat into one of these gaps. While many cars have adjustable seats that can aid in finding objects that have fallen into these gaps, seat adjustments only minimally aid in finding and reaching lost items under the seat.

The present invention overcomes the limitations of current automobile seat arrangements by providing a device that attaches to the seat of the automobile, extending pockets into the gaps to catch and secure items that drop from the seat, allowing fast and convenient retrieval of dropped items.

### BRIEF DESCRIPTION OF THE DRAWINGS

FIG. 1 is a top front right perspective view of the present invention.

FIG. 2 is a bottom rear left perspective view of the present invention.

FIG. 3 is a front elevational view of the present invention.

FIG. 4 is a rear elevational view of the present invention.

FIG. 5 is a right-side view of the present invention.

FIG. 6 is a left-side view of the present invention.

FIG. 7 is a top plan view of the present invention.

FIG. 8 is a bottom plan view of the present invention.

FIG. 9 is an illustration of the remote controller remotely communicating with the light module of the present invention.

### DETAIL DESCRIPTIONS OF THE INVENTION

All illustrations of the drawings are for the purpose of describing selected versions of the present invention and are not intended to limit the scope of the present invention.

The present invention is an automobile gap filing device configured to secure around a seat and catch dropped items. The gap filing device of the present invention comprises a connecting web 1, a plurality of gap pockets 2, a light module 3, and a remote controller 4. The light module 3 is situated within the connecting web 1 and the plurality of gap pockets 2 are outwardly and perimetrically attached to the left and right sides of the connecting web 1. The connecting web 1 and the plurality of gap pockets 2 are made from a stretchable, elastic material, allowing the automobile gap filling device to be stretched from its original shape and size, then return to its original shape and size.

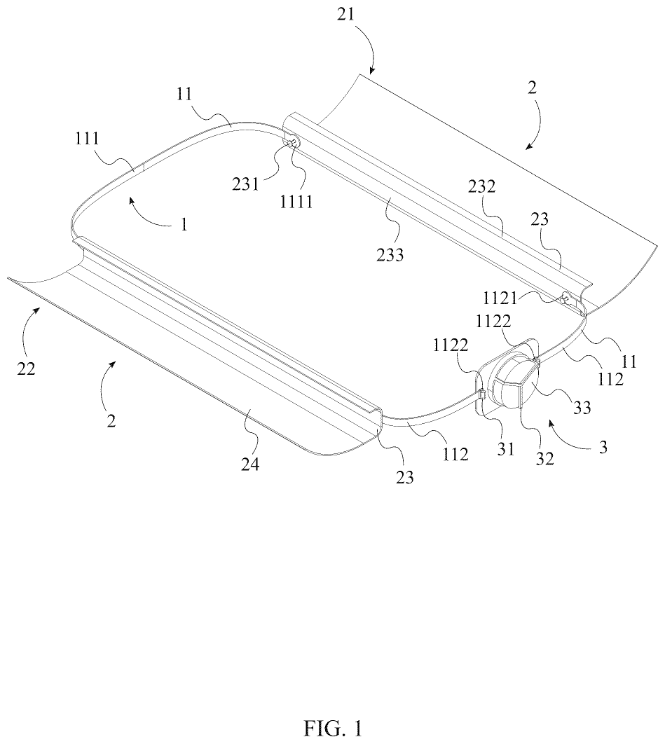

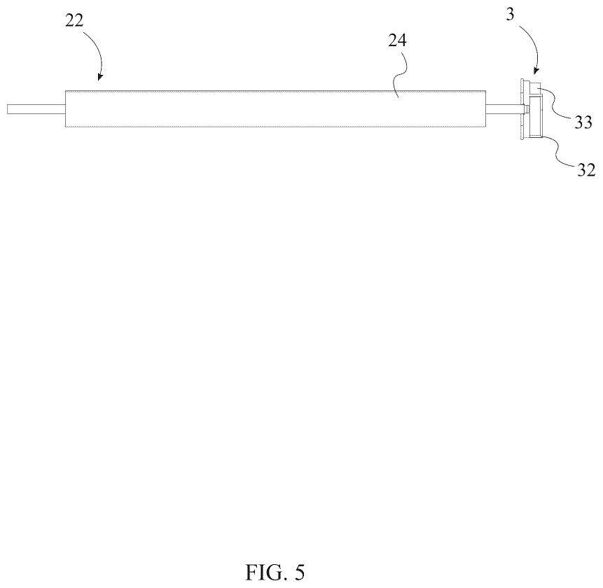

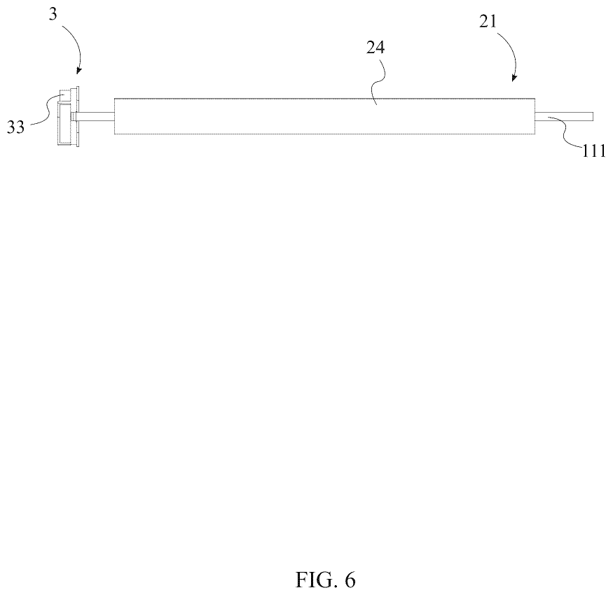

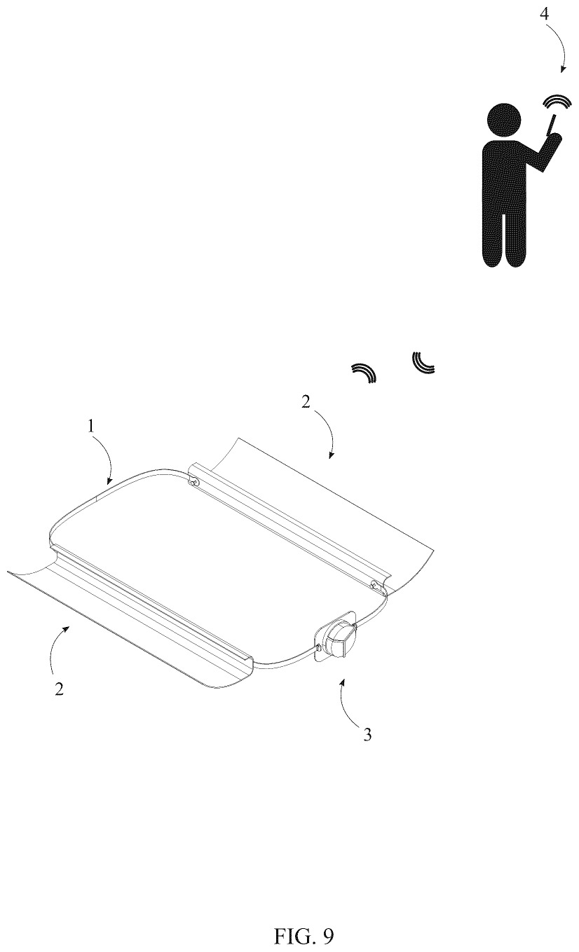

In reference to FIG. 1-9, the present invention comprises a connecting web 1, a plurality of gap pockets 2, a light module 3, and a remote controller 4. The connecting web 1 further comprises a plurality of straps 11. The plurality of straps 11 further comprises a rear strap 111 and a plurality of front straps 112. The rear strap 111 comprises a plurality of rear strap pocket loops 1111. The plurality of front straps 112 comprises a front strap pocket loop 1121 and a front strap light module fastener 1122. The plurality of gap pockets 2 comprises a left pocket 21, a right pocket 22, a gap pocket proximal end 23, and a gap pocket distal end 24. The gap pocket proximal end 23 further comprises a plurality of fasteners 231 and a top lip 232. The light module 3 comprises a plurality of fastener receivers 31, a light receiver 32, and a light fixture 33. The connecting web 1 affixes the plurality of gap pockets 2 to each other. As a result, the plurality of gap pockets 2 is positioned below the right and left side of an automobile seat. The connecting web 1 secures the present invention below an automobile seat. Consequently, the plurality of gap pockets 2 is properly positioned to receive an item falling along the right or left side of the automobile seat. The connecting web 1 receives the light module 3 along the front side of the present invention. Accordingly, the light module 3 emits a light source along the front underside of an automobile seat.

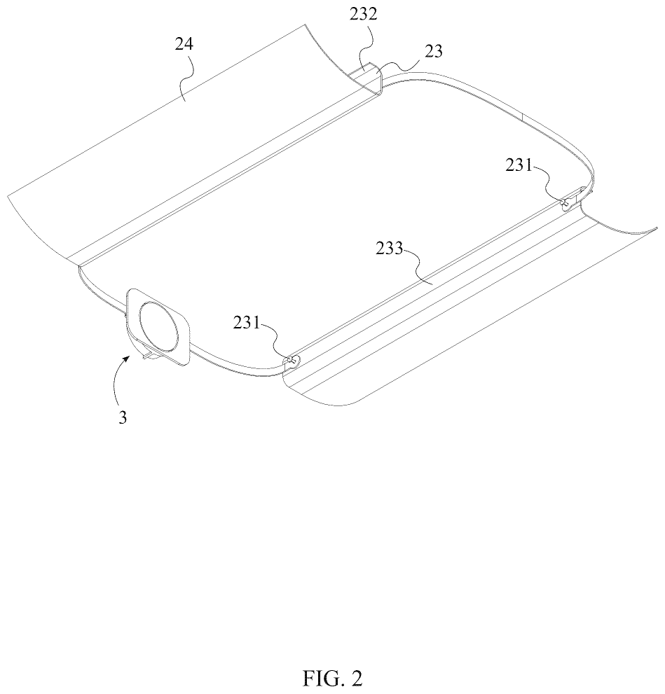

In reference to FIG. 2, the plurality of straps 11 traverses from the left side to the right side of the present invention. Thus, the plurality of straps 11 connects the right pocket 22 to the left pocket 21, both of which form the plurality of pockets. The rear strap 111 is a flexible rubber material. So, the rear strap 111 is designed to be stretched from its original shape and size, and then return to its original shape and size. The rear strap 111 secures the left pocket 21 to the right pocket 22. As a result, the rear strap 111 creates a connection along the rear side of the left pocket 21 and the right pocket 22. The plurality of front straps 112 secures the light module 3 in between the left pocket 21 and the right pocket 22. Consequently, the light module 3 is properly centered between the left and right side of the present invention and automobile seat.

Further, the plurality of rear strap pocket loops 1111 is integrated along the terminal ends of the rear strap 111 as shown in FIG. 1. Accordingly, the plurality of rear strap pocket loops 1111 forms a circular hole to receive the left pocket 21 and right pocket 22. The plurality of rear strap pocket loops 1111 has a circular shape and a flexible structure. Thus, the plurality of rear strap pocket loops 1111 is designed to receive a cylindrical shaped fastener and expand to wrap around such fastener before compressing to the original shape and size of the plurality of rear strap pocket loops 1111. The plurality of rear strap pocket loops 1111 attachment mechanism is preferably a slot or aperture.

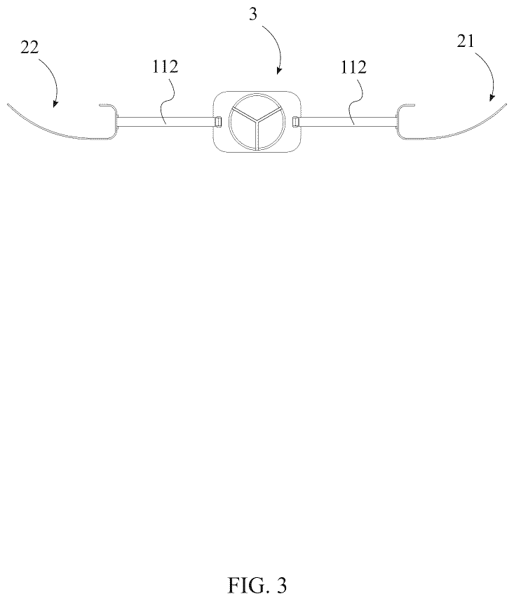

Furthermore, the front strap pocket loop 1121 integrates along a terminal end of each of the plurality of front straps 112 as seen in FIG. 3. So, the front strap pocket loop 1121 secures the front of the left pocket 21 and right pocket 22. The front strap pocket loop 1121 has a circular shape and a flexible structure. Similarly to the plurality of rear strap pocket loops 1111 the front strap pocket loop 1121 is designed to receive a cylindrical shaped fastener and expand to wrap around such fastener before compressing to the original shape and size of the front strap pocket loop 1121. The front strap light module fastener 1122 integrates along a terminal end of each of the plurality of front straps 112 opposite the front strap pocket loop 1121. As a result, the front strap light secures the light module 3 in place while not interfering with the front strap pocket loop 1121 that secures the left pocket 21 or right pocket 22.

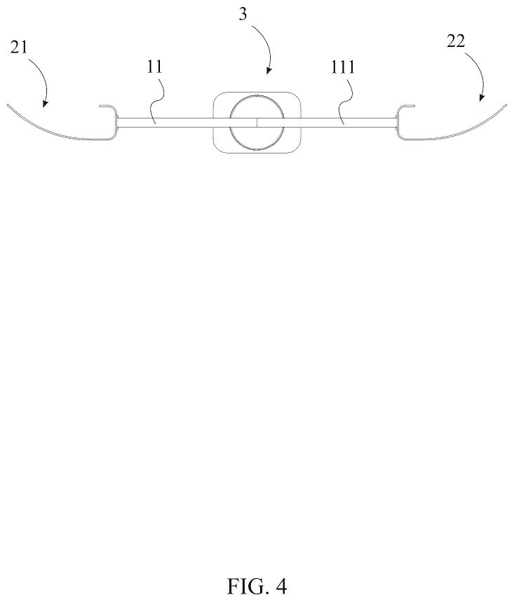

In reference to FIG. 4, the left pocket 21 is positioned opposite the right pocket 22 along the connecting web 1. Consequently, the left pocket 21 is positioned along the left side of an automobile seat while the right pocket 22 is positioned along the right side of an automobile seat. The left pocket 21 mirrors the right pocket 22 positioning. Accordingly, the left pocket 21 and the right pocket 22 each extend outwards from the center of the present invention or automobile seat.

Further, the gap pocket proximal end 23 is the side of the plurality of gap pockets 2 closest to the connecting web 1 seen in FIG. 4. Thus, the gap pocket proximal end 23 contacts the connecting web 1. The gap pocket proximal end 23 forms a U-shaped cross-section. So, the gap pocket proximal end 23 has a U-shape positioned on its side. The plurality of fasteners 231 integrates along the inner surface 233 of the gap pocket proximal end 23 along the base of the U-shaped cross-section. As a result, the plurality of fasteners 231 are exposed to the connecting web 1, allowing for a connection. The plurality of fasteners 231 inserts into the plurality of rear strap pocket loops 1111 and the front strap pocket loop 1121. Consequently, the plurality of fasteners 231 secures to the connecting web 1 via the plurality of rear strap pocket loops 1111 and the front strap pocket loop 1121. The top lip 232 forms the upper side of the U-shaped cross-section. Accordingly, the top lip 232 completes the U-shaped cross-section of the left pocket 21 and right pocket 22. Since the gap pocket distal end 24 and gap pocket proximal end 23 for each of the plurality of gap pockets 2 is made of a flexible and elastic material, the U-shaped portion of the plurality of gap pocket bends and adjusts to effectively fit within the space adjacent to an automobile seat. Once the automobile gap filling device is in place, objects that fall from the automobile seat will be caught in the U-shaped portion of one of the plurality of gap pockets 2, allowing the object to be easily retrieved.

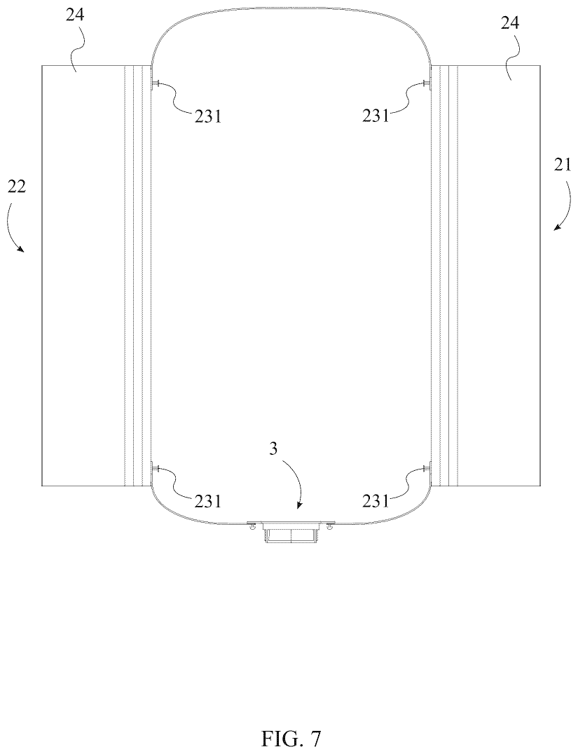

Furthermore, the gap pocket distal end 24 is positioned along the plurality of gap pockets 2 opposite the gap pocket proximal end 23 as seen in FIG. 7. Thus, the gap pocket distal end 24 and the gap pocket proximal end 23 form the plurality of gap pockets 2. The gap pocket distal end 24 curves outwards and upwards. So, this design ensure that fallen objects are caught by the plurality of gap pockets 2 and do not fall further downwards.

In reference to FIG. 1, the plurality of fastener receivers 31 integrates along the left and right side of the light module 3. The light module 3 is a square or rectangular shaped plate and is designed to provide light to the area surrounding the present invention. As a result, the plurality of fastener receivers 31 allows the light module 3 to be secured to the connecting web 1. The light receiver 32 integrates centrally along the front surface of the light module 3. Consequently, the light receiver 32 is positioned to emit a light source outwards. The light receiver 32 integrates along the light module 3 in between the plurality of fastener receivers 31. Accordingly, the light receiver 32 does not interfere with or overlap with the plurality of fastener receivers 31.

Further, the plurality of fastener receivers 31 connects the light module 3 to the connecting web 1 via the front strap light module fastener 1122. Thus, the light module 3 is secured and positioned in the front of the present invention facing outwards as seen in FIG. 7.

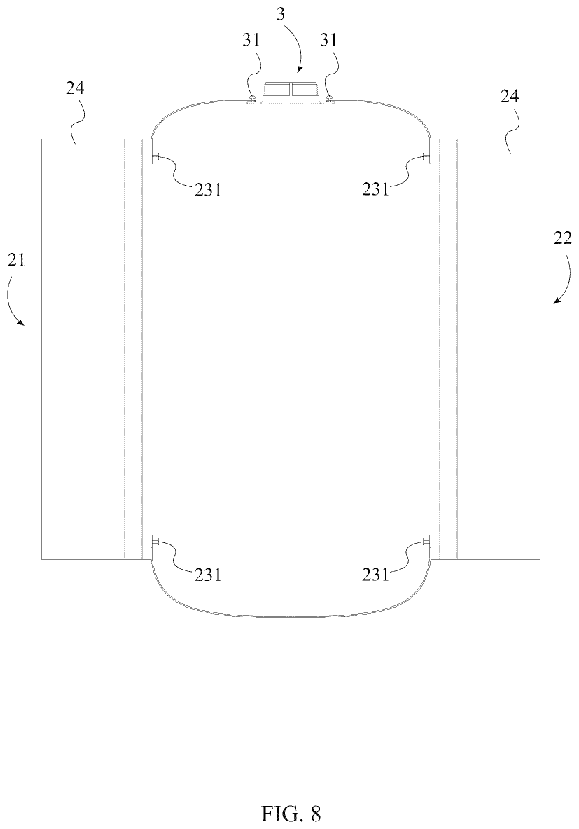

Furthermore, the light receiver 32 receives the light fixture 33 as seen in FIG. 8. So, the light fixture 33 which emits a light, is secured by the light receiver 32. The light fixture 33 is preferably an LED light. The light fixture 33 electronically and remotely connects to the remote controller 4. The light fixture 33 may be controlled by a control interface integrated within the light module 3 that communicates with the remote controller 4, such as a Bluetooth controller. As a result, the light fixture 33 turns ON and OFF based on a control signal from the remote controller 4. The light fixture 33 remotely communicates with the remote controller 4. Consequently, the light fixture 33 does not have any physical controls integrated along the light fixture 33. The light fixture 33 changes colors and light intensity based on signals received from the remote controller 4. Thus, the light fixture 33 is controlled by the remote controller 4 and receives a variety of signals which control power state, light intensity, and light color.

Although the invention has been explained in relation to its preferred embodiment, it is to be understood that many other possible modifications and variations can be made without departing from the spirit and scope of the invention as hereinafter claimed.

What is claimed is:

1. An automobile gap filling device comprising:
a connecting web;
a plurality of gap pockets;
a light module;
a remote controller;
the connecting web comprising a plurality of straps;
the plurality of straps further comprising a rear strap and a plurality of front straps;
the rear strap comprising a plurality of rear strap pocket loops;
the plurality of front straps comprising a front strap pocket loop and a front strap light module fastener;
the plurality of gap pockets comprising a left pocket, a right pocket, a gap pocket proximal end, and a gap pocket distal end;
the gap pocket proximal end further comprising a plurality of fasteners and a top lip;
the light module comprising a plurality of fastener receivers, a light receiver, and a light fixture;
the connecting web affixing the plurality of gap pockets to each other;
the connecting web securing the present invention below an automobile vehicle seat; and
the connecting web receiving the light module along the front side of the present invention.

2. The automobile gap filling device as claimed in claim 1 comprising:
the plurality of straps traversing from the left side to the right side of the present invention;
the rear strap being a flexible rubber material;
the rear strap securing the left pocket to the right pocket; and
the plurality of front straps securing the light module in between the left pocket and the right pocket.

3. The automobile gap filling device as claimed in claim 2 comprising:
the plurality of rear strap pocket loops being integrated along the terminal ends of the rear strap; and
the plurality of rear strap pocket loops having a circular shape and a flexible structure.

4. The automobile gap filling device as claimed in claim 2 comprising:
the front strap pocket loop integrating along a terminal end of each of the plurality of front straps;
the front strap pocket loops having a circular shape and a flexible structure; and
the front strap light module fastener integrating along a terminal end of each of the plurality of front straps opposite the front strap pocket loop.

5. The automobile gap filling device as claimed in claim 1 comprising:
the left pocket being positioned opposite the right pocket along the connecting web; and
the left pocket mirroring the right pocket positioning.

6. The automobile gap filling device as claimed in claim 5 comprising:
the gap pocket proximal end being the side of the plurality of gap pockets closest to the connecting web;
the gap pocket proximal end forming a U-shaped cross-section;
the plurality of fasteners integrating along the inner surface of the gap pocket proximal end along the base of the U-shaped cross-section;
the plurality of fasteners inserting into the plurality of rear strap pocket loops and the front strap pocket loop; and
the top lip forming the upper side of the U-shaped cross-section.

7. The automobile gap filling device as claimed in claim 5 comprising:
the gap pocket distal end being positioned along the plurality of gap pockets opposite the gap pocket proximal end; and
the gap pocket distal end curving outwards and upwards.

8. The automobile gap filling device as claimed in claim 1 comprising:
the plurality of fastener receivers integrating along the left and right side of the light module;
the light receiver integrating centrally along the front surface of the light module; and
the light receiver integrating along the light module in between the plurality of fastener receivers.

9. The automobile gap filling device as claimed in claim 8 wherein the plurality of fastener receivers connecting the light module to the connecting web via the front strap light module fastener.

10. The automobile gap filling device as claimed in claim 8 comprising:
the light receiver receiving the light fixture;
the light fixture electronically and remotely connecting to the remote controller;
the light fixture remotely communicating with the remote controller; and
the light fixture changing colors and light intensity based on signals received from the remote controller.

11. An automobile gap filling device comprising:
a connecting web;
a plurality of gap pockets;
a light module;
a remote controller;
the connecting web comprising a plurality of straps;
the plurality of straps further comprising a rear strap and a plurality of front straps;
the rear strap comprising a plurality of rear strap pocket loops;
the plurality of front straps comprising a front strap pocket loop and a front strap light module fastener;
the plurality of gap pockets comprising a left pocket, a right pocket, a gap pocket proximal end, and a gap pocket distal end;
the gap pocket proximal end further comprising a plurality of fasteners and a top lip;
the light module comprising a plurality of fastener receivers, a light receiver, and a light fixture;
the connecting web affixing the plurality of gap pockets to each other;
the connecting web securing the present invention below an automobile vehicle seat;
the connecting web receiving the light module along the front side of the present invention;
the plurality of straps traversing from the left side to the right side of the present invention;
the rear strap being a flexible rubber material;
the rear strap securing the left pocket to the right pocket; and
the plurality of front straps securing the light module in between the left pocket and the right pocket.

12. The automobile gap filling device as claimed in claim 11 comprising:
the plurality of rear strap pocket loops being integrated along the terminal ends of the rear strap;
the plurality of rear strap pocket loops having a circular shape and a flexible structure;
the front strap pocket loop integrating along a terminal end of each of the plurality of front straps;
the front strap pocket loops having a circular shape and a flexible structure; and
the front strap light module fastener integrating along a terminal end of each of the plurality of front straps opposite the front strap pocket loop.

13. The automobile gap filling device as claimed in claim 11 comprising:
the left pocket being positioned opposite the right pocket along the connecting web;
the left pocket mirroring the right pocket positioning;
the gap pocket proximal end being the side of the plurality of gap pockets closest to the connecting web;
the gap pocket proximal end forming a U-shaped cross-section;
the plurality of fasteners integrating along the inner surface of the gap pocket proximal end along the base of the U-shaped cross-section;
the plurality of fasteners inserting into the plurality of rear strap pocket loops and the front strap pocket loop; and
the top lip forming the upper side of the U-shaped cross-section.

14. The automobile gap filling device as claimed in claim 13 comprising:
the gap pocket distal end being positioned along the plurality of gap pockets opposite the gap pocket proximal end; and
the gap pocket distal end curving outwards and upwards.

15. The automobile gap filling device as claimed in claim 11 comprising:
the plurality of fastener receivers integrating along the left and right side of the light module;
the light receiver integrating centrally along the front surface of the light module;
the light receiver integrating along the light module in between the plurality of fastener receivers; and
the plurality of fastener receivers connecting the light module to the connecting web via the front strap light module fastener.

16. The automobile gap filling device as claimed in claim 15 comprising:
the light receiver receiving the light fixture;
the light fixture electronically and remotely connecting to the remote controller;
the light fixture remotely communicating with the remote controller; and
the light fixture changing colors and light intensity based on signals received from the remote controller.

17. An automobile gap filling device comprising:
a connecting web;
a plurality of gap pockets;
a light module;
a remote controller;
the connecting web comprising a plurality of straps;
the plurality of straps further comprising a rear strap and a plurality of front straps;
the rear strap comprising a plurality of rear strap pocket loops;
the plurality of front straps comprising a front strap pocket loop and a front strap light module fastener;
the plurality of gap pockets comprising a left pocket, a right pocket, a gap pocket proximal end, and a gap pocket distal end;
the gap pocket proximal end further comprising a plurality of fasteners and a top lip;
the light module comprising a plurality of fastener receivers, a light receiver, and a light fixture;
the connecting web affixing the plurality of gap pockets to each other;
the connecting web securing the present invention below an automobile vehicle seat;
the connecting web receiving the light module along the front side of the present invention;
the plurality of straps traversing from the left side to the right side of the present invention;
the rear strap being a flexible rubber material;
the rear strap securing the left pocket to the right pocket;
the plurality of front straps securing the light module in between the left pocket and the right pocket;
the plurality of rear strap pocket loops being integrated along the terminal ends of the rear strap;
the plurality of rear strap pocket loops having a circular shape and a flexible structure;
the front strap pocket loop integrating along a terminal end of each of the plurality of front straps;
the front strap pocket loops having a circular shape and a flexible structure; and
the front strap light module fastener integrating along a terminal end of each of the plurality of front straps opposite the front strap pocket loop.

18. The automobile gap filling device as claimed in claim 17 comprising:
the left pocket being positioned opposite the right pocket along the connecting web;
the left pocket mirroring the right pocket positioning;
the gap pocket proximal end being the side of the plurality of gap pockets closest to the connecting web;
the gap pocket proximal end forming a U-shaped cross-section;
the plurality of fasteners integrating along the inner surface of the gap pocket proximal end along the base of the U-shaped cross-section;
the plurality of fasteners inserting into the plurality of rear strap pocket loops and the front strap pocket loop;
the top lip forming the upper side of the U-shaped cross-section;
the gap pocket distal end being positioned along the plurality of gap pockets opposite the gap pocket proximal end; and
the gap pocket distal end curving outwards and upwards.

19. The automobile gap filling device as claimed in claim 17 comprising:
the plurality of fastener receivers integrating along the left and right side of the light module;
the light receiver integrating centrally along the front surface of the light module;
the light receiver integrating along the light module in between the plurality of fastener receivers; and
the plurality of fastener receivers connecting the light module to the connecting web via the front strap light module fastener.

20. The automobile gap filling device as claimed in claim 19 comprising:
the light receiver receiving the light fixture;
the light fixture electronically and remotely connecting to the remote controller;
the light fixture remotely communicating with the remote controller; and
the light fixture changing colors and light intensity based on signals received from the remote controller.
